(19) United States
(12) Patent Application Publication
(10) Pub. No.: US 2003/0079051 A1
(43) Pub. Date: Apr. 24, 2003

(54) Method and system for the internationalization of computer programs employing graphical user interface

(76) Inventors: Dean Moses, San Francisco, CA (US); Peter Leiser, Berkeley, CA (US); Ethan Vonderweid, San Francisco, CA (US); Miles Chaston, San Francisco, CA (US); Thomas Belinus, San Francisco, CA (US); Noah Guyot, San Francisco, CA (US)

Correspondence Address: SWIDLER BERLIN SHEREFF FRIEDMAN, LLP, 3000 K STREET, NW, BOX IP, WASHINGTON, DC, 20007, US

(21) Appl. No.: 09/983,406

(22) Filed: Oct. 24, 2001

(51) Int. Cl. G06F 9/00

(52) U.S. Cl. 709/328; 345/741; 345/746

(57) ABSTRACT

Management of the internationalization of software applications of a portal framework employs a navigation graphical user interface. A set of available locales for objects are provided to a first set of users as defined by a set of permissions for each locale in the set of locales. Each locale in the set of available locales represents a cultural scenario that is stored as a property file. Locales can be added to, and removed from, the portal framework in accordance with administrative privileges employing a graphical user interfaces. Locales can be edited for uploading to the portal framework in accordance with administrative privileges employing a graphical user interfaces. Locales can downloaded to the portal framework in accordance with administrative privileges employing a graphical user interfaces. Permission for locales may be set

### BACKGROUND OF THE INVENTION

1. Field of the Invention

The present invention relates to a method, a system and computer program product for translating software applications. More particularly, the present invention relates to a method, a system and a computer program product for creating multi-cultural software applications that enable aspects of the software application to operate according to a cultural scenario (“locale”).

2. Description of the Prior Art

Software applications are often required to serve users with different locale, such as language. Generally, the requirement for software applications to function according to various locales is due to distribution of the software applications to different countries, or the use of the software applications by nationals of different countries or different nationals in the same country. Designing software applications to meet the needs of different locales is a difficult task.

Generally, creating software applications that meet the needs of different locales involves the manipulation of culturally dependent data associated with the display files of the software application. Culturally dependent data is any data that varies from one culture or country to another, such as language. Most of this cultural dependent data is in a text formal, but could have other formats including times, dates, numeration, illustrations and even sound. Developers have implemented a number of techniques to enable software applications to function under and meet the needs associated with various locales.

One such technique involves developing a form of the software application for each possible locale, such as for each language. Unfortunately, this technique suffers from a number of drawbacks. The first drawback is the substantial amount of time and effort required developing the different forms of the same software application. Another drawback is that the different forms of the software application must be tracked to insure distribution of each form of the software application to the correct location in accordance with the locale.

Another technique implemented to provide software applications that function under various locales involves adapting the software application during execution. The technique includes identifying, removing and replacing culturally dependent data from each display file for the software application with corresponding culturally translated data. However, the software application accesses culturally translated data during execution employing key value pairs. The key value pairs reference the culturally translated data, which is stored in a separate file, one for each locale. The key value pairs are referenced from the software application and used to load the appropriate text from the file for the locale in use. Key value pairs are stored as resource bundles. A resource bundle is stored as a property file having a plain text format. Each cultural scenario that is intended to be used has it's own resource bundle, and thus a corresponding property file. This techniques does not enable locating and loading of an appropriate property file at run-time.

There is a need for a new method of adapting software applications based on cultural scenarios during run-time. There is a further need for a new method for dynamically adding and deploying locales to a software application. There is also a need for the locales to be provided to a particular group of user based on administrative permission settings. There is a need for a new framework for adapting software applications based on cultural scenarios during run-time. There is a need for a new framework to allow adapting software applications based on cultural scenarios accessible to users and administrators through web browsers or the like. There is a need for a new framework to deploy locales corresponding to a cultural scenario. There is a need for a computer program product for adapting software applications based on cultural scenarios during run-time.

### SUMMARY OF THE INVENTION

According to embodiments of the present invention, a method, a framework and a computer program product for managing the internationalization of software applications during run-time are provided. Key value pairs are provided as resource bundles. The framework is a scalable, secure, enterprise class software platform for enabling software applications to function under various cultural scenarios at run-time. The framework provides a platform to develop and deploy cultural scenarios under which these software applications may function. A web browser or the like provides the interface for the development and deployment of these locales to software applications. The locales are deployed to sets of users based on permissions, which may enable the set of users to further delegate privileges for the locale to another set of users.

According to an embodiment of the present invention, a method of managing internationalization of software applications of a portal framework includes accessing an available object from a list of available objects associated with an available object group. A set of available locales for the available object is provided to a first set of users as defined by a set of permissions for each locale in the set of locales. Each locale in the set of available locales represents a cultural scenario. The available object is associated with an internationalized software application.

In an embodiment of the present invention, the method further includes adding the set of available locales to the portal framework. The set of available locales are added by a second set of users having a first set of administrative privileges associated with the set of available locales.

In an embodiment of the present invention, the method further includes editing a locale in the set of available locales as specified by the first set of users. Editing the locale in the set of locales includes modifying localization information. The method further includes storing the modified localization information. A second permission in the set of permissions enables the first set of users to edit the locale in the set of available locales.

In an embodiment of the present invention, the method further includes traversing a hierarchical path to access the available object.

In an embodiment of the present invention, the method further includes selecting an available locale in the set of available locales as one of: a default framework-wide locale and a default system-wide locale.

In an embodiment of the present invention, the method further includes removing the set of available locales from the portal framework. The set of available locales are removed by a second set of users having a first set of administrative privileges associated with the set of available locales.

According to an embodiment of the present invention, a computer program product for managing the internationalization of software applications of a portal framework includes a computer readable medium having computer program instructions executable by a processor stored thereon. The computer program instructions are operable to access an available object from a list of available objects associated with an available object group and provide a set of available locales for the available object to a first set of users as defined by a set of permissions for each locale in the set of locales. Each locale in the set of available locales represents a cultural scenario. The available object is associated with a software application.

According to an embodiment of the present invention, a system for managing the internationalization of software applications of a portal framework including a system operable to access an available object from a list of available objects associated with an available object group. The system also includes a database operable to provide a set of available locales for the available object to a first set of users as defined by a set of permissions for each locale in the set of locales, each locale in the set of available locales representing a cultural scenario. The available object is associated with a software application.

### BRIEF DESCRIPTION OF THE DRAWINGS

The above described features and advantages of the present invention will be more fully appreciated with reference to the detailed description and appended figures in which:

FIG. 1 depicts a functional block diagram of a framework in which the present invention can find application;

FIG. 2 depicts a functional block diagram of a user system depicted in FIG. 1;

FIG. 3 depicts a functional block diagram of a system depicted in FIG. 1;

FIG. 4 depicts a functional block diagram of a system depicted in FIG. 1;

FIG. 5 is an exemplary block diagram of the application programming interface (API) illustrated in FIG. 3;

FIG. 6 depicts a method of according to embodiments of the present invention;

FIG. 7 depicts a graphical user interface for administering internationalization and localization according to embodiments of the present invention;

FIG. 8 depicts a delegated administration interface for managing permissions for the internationalization system according to embodiments of the present invention; and

FIG. 9 depicts an end user client view interface for presenting to the end user the particular objects of an instances of a software application.

### DETAILED DESCRIPTION OF THE INVENTION

The present invention is now described more fully hereinafter with reference to the accompanying drawings that show embodiments of the present invention. The present invention, however, may be embodied in many different forms and should not be construed as limited to embodiments set forth herein. Appropriately, these embodiments are provided so that this disclosure will be thorough and complete, and will fully convey the scope of the present invention.

According to embodiments of the present invention, a method, a framework and a computer program product for managing internationalization of software applications during run-time are provided. Internationalizing includes the ability to create, modify, add cultural scenarios (“locales”) under which a software application may operate, remove locales under which a software application may operate and set permission to assign privileges for users to manage locales. Cultural scenarios are defined by key value stored in a separate file, one for each locale available to a software application. Key value pairs are provided as resource bundles in the software language of origin, such as English. A locale is stored as a property file having a plain text format. Each locale has a corresponding property file. Locales follow a naming convention so software applications can locate and load a property file at run time. The naming convention may use language and country codes that are made part of the file name.

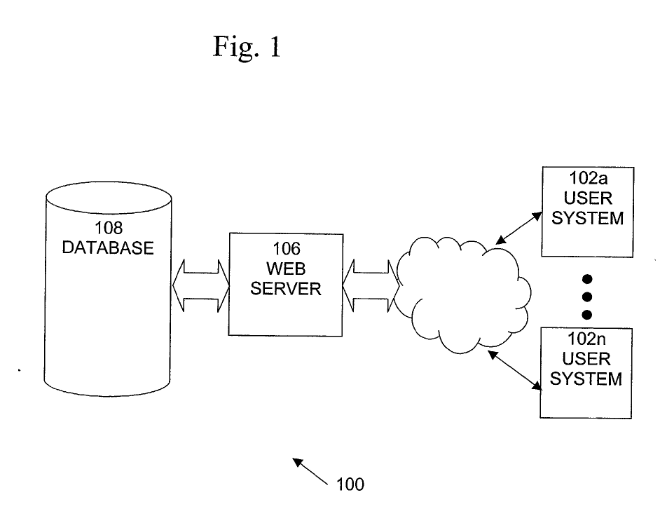

FIG. 1 depicts a functional block diagram of a framework in which the present invention can find application. In the embodiment of FIG. 1, framework 100 may be implemented to create multi-cultural software applications that enable aspects of software applications to operate according to a cultural scenario during run-time in a portal environment. Framework 100 includes user systems 102 connected to a system 106 employing network 104. Framework 100 may transmit using network 104, any combination of voice, video and/or data between devices. User systems 102 may be any apparatus from which, and to which, any combination of voice video and/or data may be transmitted over a network 104, such as the Internet or an extranet. User systems 102 can include computers, web access devices, workstations, telecommunication devices, and the like. Systems 102 may be used to access system 106 internationalize instances of software applications and localize aspects of an internationalized instance of a software application.

System 106 is couple to system 108 and network 104. System 106 can be any computer that stores instances of software applications for access by users, accesses and stores cached property files of internationalized software application instances, uses libraries, such as Java libraries, and provides the functionality to manage internationalization of instances of software applications. In the preferred embodiment of the present invention, system 106 supports Java Server Pages (JSP). The system 106 provides a scalable, secure, enterprise class software platform for software applications, such as web, business and email-based applications. An individual or a number of individuals, who are responsible for hosting software applications, may leverage existing code of pre-existing software applications to facilitate the internationalization of software applications of a software application employing a visual environment.

The system 108 may be any computer that stores resource bundles available to instances of software applications available on systems of system 100 as property files. Property files follow a naming convention so software applications can locate and load a property file at run-time. The naming convention may use language and country codes that are made part of the file name. An individual or individuals responsible for hosting software applications on a system of system 100 as well as an individual or individuals that participate in accessing system 106 to perform internationalization functions on software applications available on system 106 may use system 108.

User systems 102 and system 106 may connect to one another by means of a suitable communications network 104. Network 104 may be a local area network, a wide area network, the Internet, an extranet, a wireless network, or the like. The network 104 may transfer information between user system 102 and system 106. The information transferred may include any combination of voice, video and/or data. Network 104 can be implemented as a wireless network or a wired network. In addition, system 108 may directly transfer information to system 106 in response to a request for information as well as transfer information to user system 102 in response to a request made to system 106 by user system 102 over network 104.

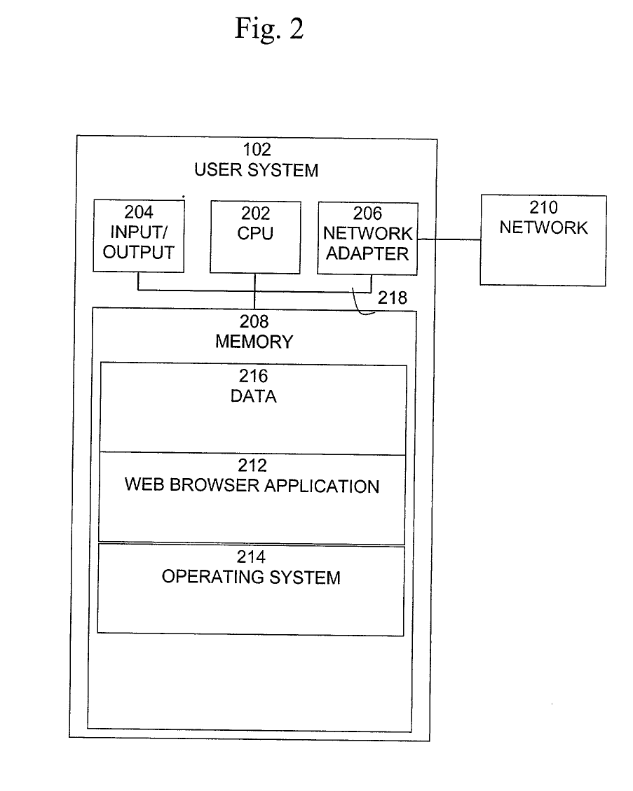

FIG. 2 is a block diagram illustration of user systems 102. The user systems 102 may include CPU 202, connected by a bus 218 or other suitable interface means to system memory 208 and network interface 210. In the embodiment of FIG. 2, CPU 202 is a microprocessor, such as an INTEL PENTIUM® or AMD® processor, but may be any processor that executes program instructions in order to carry out the functions of the present invention. As shown, CPU 202 and the various other components of the system 102 communicate through a system bus 218 or similar architecture. Network interface 310 provides an interface between system 106 and a network 104, such as the Internet. The network 104 may be a local area network (LAN), a wide area network (WAN), or combinations thereof. The user system 102 can also include input/output device interface, and display interface 204. Input/output device interface 204 enables interaction with and execution of instruction by user system 102 as directed by a user. Display interface can display information generated for output by user system 102 as provided by system 106. Systems memory 208 includes Browser program 212, operating system 214 and data 216.

Operating system 214 provides overall system functionality. Browser program 212 is computer program instructions executed by CPU 202. The browser program 212 enables the information transmitted from system 106 to be conveyed to a user in a manner that can be understood by a user of user system 102. The browser program 212 serves as a front end to the World Wide Web on the Internet. The browser program 212 may be used to access system 106 to display interfaces to manage internationalization of instances of software applications in accordance with privileges as defined by permissions assigned to users for locales.

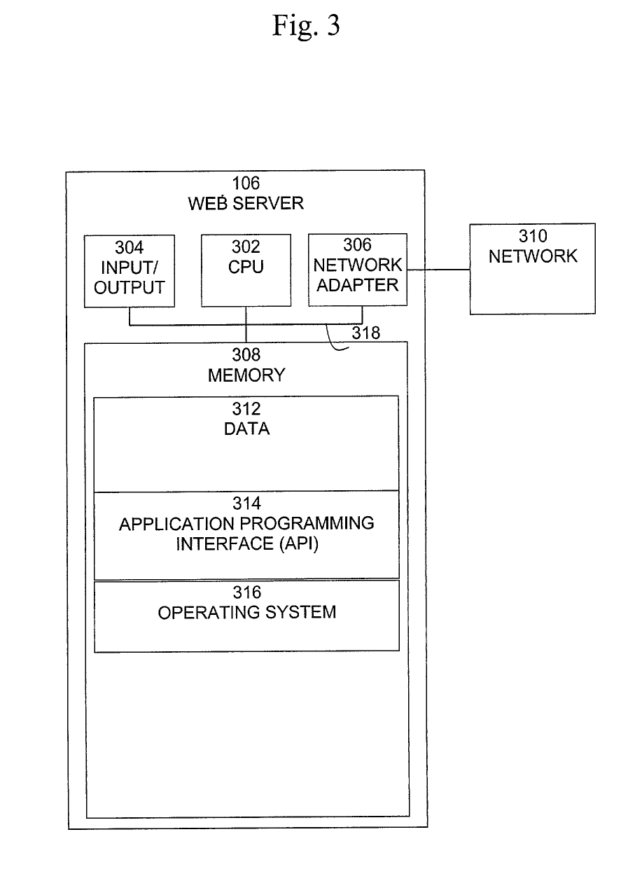

FIG. 3 is an exemplary block diagram of system 106 illustrated in FIG. 1, in which the present invention may be implemented. System 106 performs the function of internationalizing instances of software applications. The system 106 provides a scalable, secure, enterprise class software platform for web, business and email-based applications. In the FIG. 3 embodiment, system 106 is a general purpose computer, such as a workstation, personal computer, server or the like, but may be any apparatus that executes program instruction in accordance with the present invention. System 106 includes a processor (CPU) 302 connected by a bus 318 to memory 308, network interface 310 and I/O circuitry 304.

In the FIG. 3 embodiment, CPU 302 is a microprocessor, such as an INTEL PENTIUM® or AMD® processor, but may be any processor that executes program instructions in order to carry out the functions of the present invention. As shown, CPU 302 and the various other components of the system 106 communicate through a system bus 318 or similar architecture. Network interface 310 provides an interface between system 106 and a network 104, such as the Internet. The network 104 may be a local area network (LAN), a wide area network (WAN), or combinations thereof. I/O circuitry 304 provides an interface for the input of structured information to and output of structured information from system 106. I/O circuitry 304 includes input devices, such as trackball, mice, touchpads and keyboards, and output devices, such as printers and monitors.

In the FIG. 3 embodiment, memory 308 stores Application Programming Interface (API) 314, operating system 316 and data 312. Operating system 316 provides overall system functionality. Data 312 may be any structured data required by system 106, such as cached property files and instances of software applications. Instances of software applications are available software applications instantiated on a system, such as system 106. Instances of software applications include web pages, web services, and objects capable of being localized. Cached property files are property files for locales that have been temporarily stored locally on system 106. This allows access to property files without accessing system 108 for every operation. The retrieval of the user data may be managed by a data access mechanism. Application programming interface 314 provides the functionality associated with managing internationalization of an instance of a software application as executed by CPU 302.

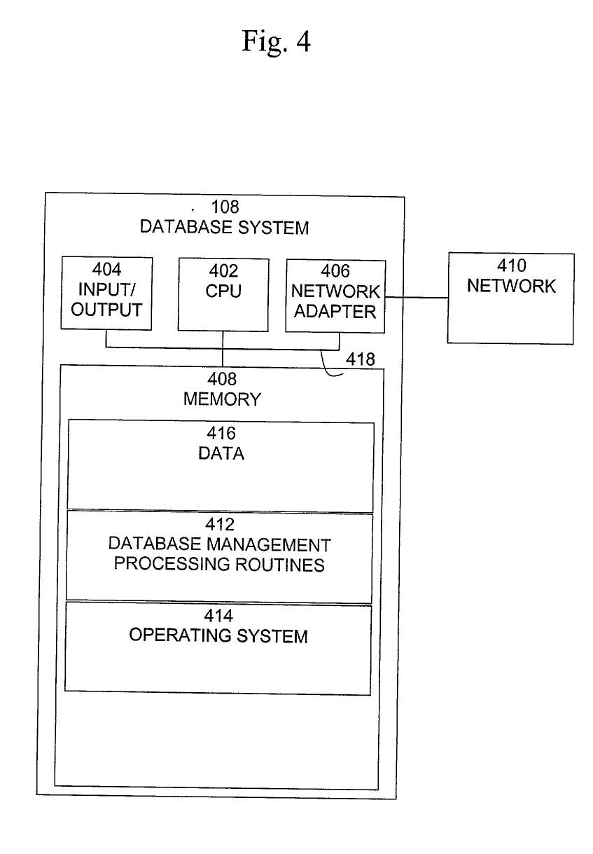

FIG. 4 is an exemplary block diagram of system 108 illustrated in FIG. 1, in which the present invention may be implemented. System 108 may be a localized resource database management system that includes property files corresponding to resource bundles retrieved by system 106 and employed by users of network 104. In the FIG. 4 embodiment, system 108 is a general purpose computer, such as a workstation, personal computer, server or the like, but may be any apparatus that executes program instruction in accordance with the present invention. System 108 includes a processor (CPU) 402 connected by a bus 418 to memory 408, network interface 410 and I/O circuitry 404.

In the FIG. 4 embodiment, CPU 402 is a microprocessor, such as an INTEL PENTIUM® or AMD® processor, but may be any processor that executes program instructions in order to carry out the functions of the present invention. As shown, CPU 402 and the various other components of the server 108 communicate through a system bus 418 or similar architecture. Network interface 410 provides an interface between system 108 and a network 104, such as the Internet. The network 104 may be a local area network (LAN), a wide area network (WAN), or combinations thereof. I/O circuitry provides an interface for the input of structured information to and output of structured information from system 108. I/O circuitry 404 includes input devices, such as trackball, mice, touchpads and keyboards, and output devices, such as printers and monitors.

In the FIG. 4 embodiment, memory 408 stores data 416, such as resource bundles, used by system 100. Memory 408 includes routines, such as database management routines 412, and operating system 414. Memory 408 includes memory devices, such as read only memory (ROM), random access memory (RAM) hard disks, CD-ROMs, floppy disks, optical storage devices, magnetic storage devices, etc.

Data 416 includes key value pairs. Key value pairs are provided as resource bundles stored as property files. Property files have a plain text format. Each locale that is intended to be used for a software application has it's own resource bundle, and accordingly, its own property file. The key value pairs are located and loaded at run-time file for the language in use. Each property file follows a naming convention so an appropriate internationalized software application can easily locate and load the correct property file at run time. The naming convention uses language and country codes that may be made part of the file name. The language and country may both be included because a locale, such as English language, may vary between countries. For example, United States English and Australian English are a little different, and Swiss German and Austrian German both differ from each other and from the German spoken in Germany.

Operating system 414 provides overall system functionality, such as management of routines in memory 412. Management routines 412 provide data management functionality.

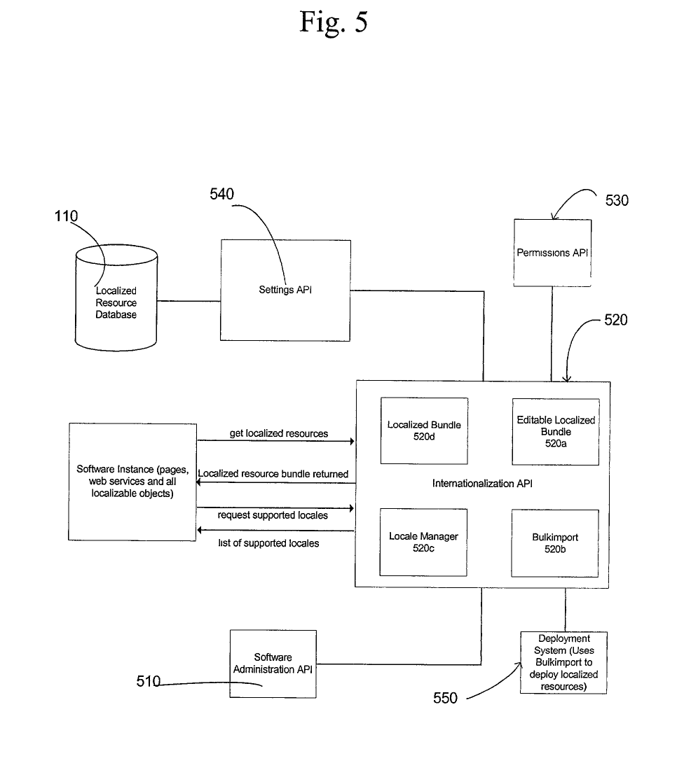

FIG. 5 is an exemplary block diagram of the application programming interface (API) illustrated in FIG. 3, in which the present invention may be implemented. In the FIG. 5 embodiment, API 312 includes software administration API 510, internationalization API 520, permissions API 530, settings API 540 and deployment system 550. API 312 performs the function of managing internationalization an instance of a software application.

Software administration API 510 receives commands from users of system 100, such as various program administrators operating from attendant consoles, for example, associated system 106. The software administration API 510 communicates with the internationalization API 520. The internationalization API 520 includes a locale manager 520c, bulk import 520b, localized bundle 520d and editable localized bundle 520a. The software administration API 510 uses the locale manager 520c to add or remove property files from system 108. The software administration API 510 also uses the locale manager 520c to coordinate and set permissions for each locale employing the permissions API 530.

The Permissions API 530 handles the permissions for each locale and localized bundle. Each locale will have a permission setting specifying that it is available, such as enable permission. This permission allows a site administrator to specify which groups of users, such as end-users on a per-site or per-group of users basis, may access/view which locales on the site or sites that the administrator has administrative permission over. The localized bundle has two permissions, such as an edit permission and an enabled permission. The edit permission allows for the editing of a particular property file. The enabled permission specifies whether the property file is currently available by a user, such as an end-user for use/viewing by instances of software applications. This allows for the creation of property files without allowing the property files to be used by end-users. There is also a can choose end user locales permission that is a based on a user group permission. This permission allows the administrative user to determine the locales that are made available to end-users. The main difference between this permission and end user available permission setting is this permission works across multiple sites while end user available works within a site.

In the FIG. 5 embodiment, selection of an object, such as a page, a function, a web service or a document for an instance of a software application that has available locales, initiates a request, such as get localized resources, from the instance of the software application to the Localized Bundle 520d process in the Internationalization API 520. Localized bundle 520d processes the request and retrieves the appropriate locale from system 108 via the settings API 540. The Settings API 540 manages the actual retrieval/storage process from system 108 and provides caching of locales. The localized bundle process 520d then returns the appropriate locale to the instance of the software application. The locale is implemented by the instance of the software application enabling the display of all of the requested localized objects. The deployment API 550 implements the locale on the object of the instance of the software application.

In the FIG. 5 embodiment, selection of an object, such as a page, a function, a web service or a document for an instance of a software application that has available locales, initiates a request, such as edit localized resources, from the instance of the software application to the Editable Bundle 520a process in the Internationalization API 520. Editable bundle 520a processes the request and edits the appropriate locale in system 108 via the settings API 540. The Settings API 540 manages the actual retrieval/storage process from system 108 and provides caching of locales. The editable bundle process 520a then stores the appropriate locale.

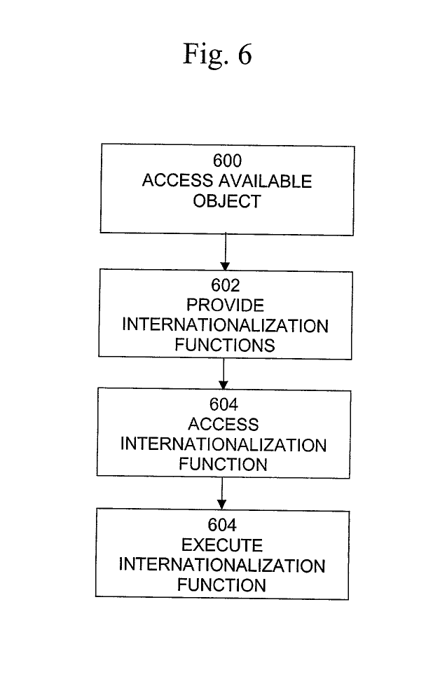

In the embodiment of FIG. 6, an exemplary flow diagram of a method of managing the internationalization of software applications of a portal framework employing hierarchical navigation menus on graphical user interfaces is illustrated. In step 600, an available object may be accessed. The available object may be accessed by selecting a description of the available object on a list of descriptions for available objects provided on a hierarchical navigational menu of a graphical user interface. The available objects are a sub-set of a category of objects that corresponds to components of an instance of a software application in portal framework 100. The list of descriptions for available objects may include module types, page types, service types, page instances, module instances, module category instances, template instances and style instances. Detailed descriptions of module types, page types, service types, page instances, module instances, module category instances, template instances and style instances are provided in U.S. patent application having Ser. No. 09/573,226 herein incorporated by reference. In an embodiment of the present invention, the available objects provided on the list of descriptions for available objects is defined by privileges. Privileges are assigned to users, such as site administrators, delegated users and end users, to define the users access to, and administrative functions performable by the users on objects in framework 100. The list of descriptions for available objects may be accessed by traversing a path of the hierarchical navigational menu.

In step 602, administrative internationalization functions executable on the available object are provided in response to selection of an available object. In an embodiment of the present invention, administrative internationalization functions executable on the available object are provided based on privileges. Privileges are assigned to users, such as site administrators, delegated users and end users, to define the users access to, and administrative internationalization functions executable by the users on locales of objects in framework 100. The privileges are assigned by setting permissions for locales of objects in the framework 100. The administrative internationalization functions executable on objects may be provided on a list of descriptions for administrative functions. The list of descriptions for administrative functions may be provided on a hierarchical navigational menu. The hierarchical navigational menu may be provided on a graphical user interface in response to selection of an available object.

In an embodiment of the present invention, the administrative functions provided on the list of descriptions for administrative functions are defined by privileges assigned to users for the available object. The administrative functions may include adding a locale to the framework 100, removing a locale from framework 100, uploading a resource bundle to the framework 100, downloading a resource bundle from the framework 100, set permissions for locales of objects, set default locales, set framework locale modes, edit locales and set locales for an available object.

In step 604, an administrative internationalization function may be accessed. The administrative internationalization function may be accessed by selecting a description of the administrative internationalization function on a list of descriptions for administrative internationalization function provided on a hierarchical navigational menu of a graphical user interface.

In step 606, an administrative internationalization function may be executed on an available object in response to accessing an administrative internationalization function. If an add locale function is executed, a user with administrative privileges, such as a top level administrator, can register locales on framework 100. If a removing locale function is executed, a user with administrative privileges, such as a top level administrator, can unregister locales on framework 100. If an upload resource bundle function is executed, a user with administrative privileges to execute administrative functions on a locale of an object can retrieve the property file for the locale. If a download resource bundle function is executed, a user with administrative privileges to execute administrative functions on a locale of an object can store the property file for the locale. If a set permission for locale function is executed, a user with the appropriate administrative privileges, such as a top level administrators, delegated administrators, and users, can view and edit the permissions for a locale of an object. If a set default locale function is executed, a user with the appropriate administrative privileges can designate a locale as the default locale for the framework or a site within the framework. If a set framework locale mode function is executed, a user with the appropriate administrative privileges can configure the system to employ the locale designated as the default locale for the framework exclusively within a site of the framework or employ the locale designated as the default locale for a site within the framework exclusively within a site of the framework. If an edit locale function is executed, a user with the appropriate administrative privileges can assign the values of keys or the keys and values of key within a resource bundle for a locale. The assigned values or keys and values may be stored. In an embodiment of the present invention, a description is provided for each key/value pair assigned. If a set locale for an available object function is executed, a user with the appropriate administrative privileges can configure the object to employ a locale. Upon completing execution of the internationalization function

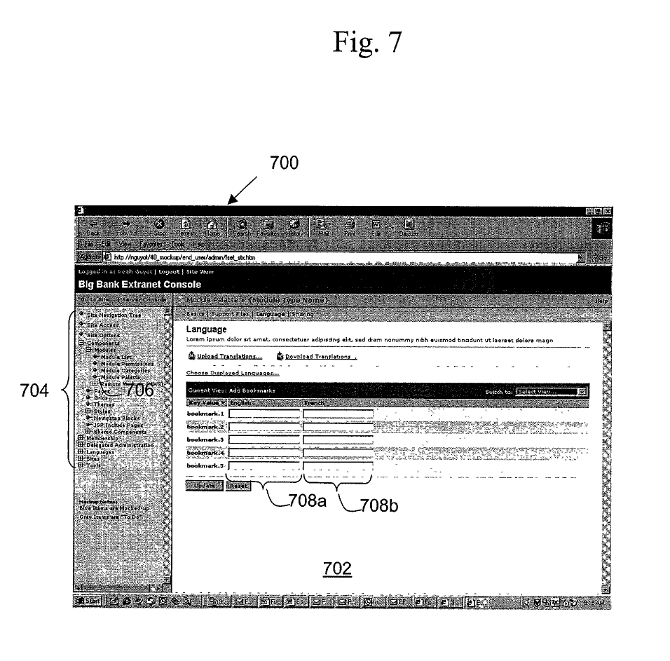

In the embodiment of FIG. 7, a graphical user interface for administering internationalization and localization according to embodiments of the present invention is depicted. The graphical user interface 700 presents a localization view 702 having a hierarchical navigational menu 704 for an object 706. In the embodiment of FIG. 7, the object is a bookmark module. The graphical user interface presents the administrator with a set of forms 708a-708b for each locale, such as. English and French. The forms enable the entry of values for keys or keys and values for each locale. An update button 710 is provided to save the values entered into the forms. Options are provided to upload the saved key/value pairs to a resource bundle or download a given set of key/value from a resource bundle already stored in the system. A manage locales option allows for top-level administrators, those whom have the highest level of permission to add or remove locales from the system via the graphical user interface. Users that have lower level administrative permissions (i.e. site administrators) can select what locales are to be made available to the end users that they have permission over.

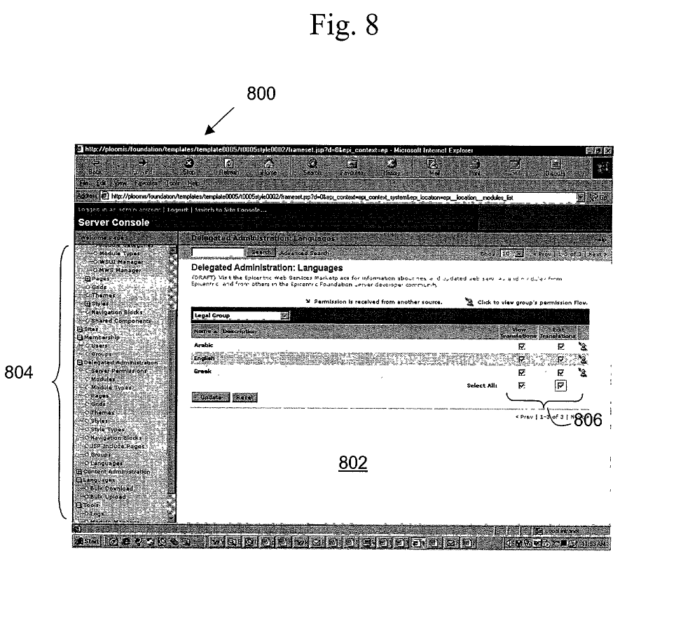

In the embodiment of FIG. 8, a delegated administration graphical user interface for managing permissions for the internationalization system according to embodiments of the present invention is depicted. This graphical user interface 800 allows for a users, such as a site administrators, to determine whether a given group of users, such as students, can provide translations to any number of objects, such as modules. The graphical user interface 800 presents a permission view 802 having a hierarchical navigational menu 804 and permission settings 806 for locales of an object. The user can set other items to give end user permissions to localize including, but not limited to pages, styles, templates etc, which are all selectable via the hierarchical navigational menu.

Another feature allows for the selection of a default locale for the entire system of sites through the choose system mode option. This option is only present to the top-level administrator. This option also allows for the administrator to restrict a site to only one locale permanently or temporarily, which allows for localization to be completed for a given object/page/site before it is exposed to end-users. Another option allows for the administrators to place the system in a site-wide multi-locale mode, which a given site can use multiple locales simultaneously and end users can choose their preferred locale.

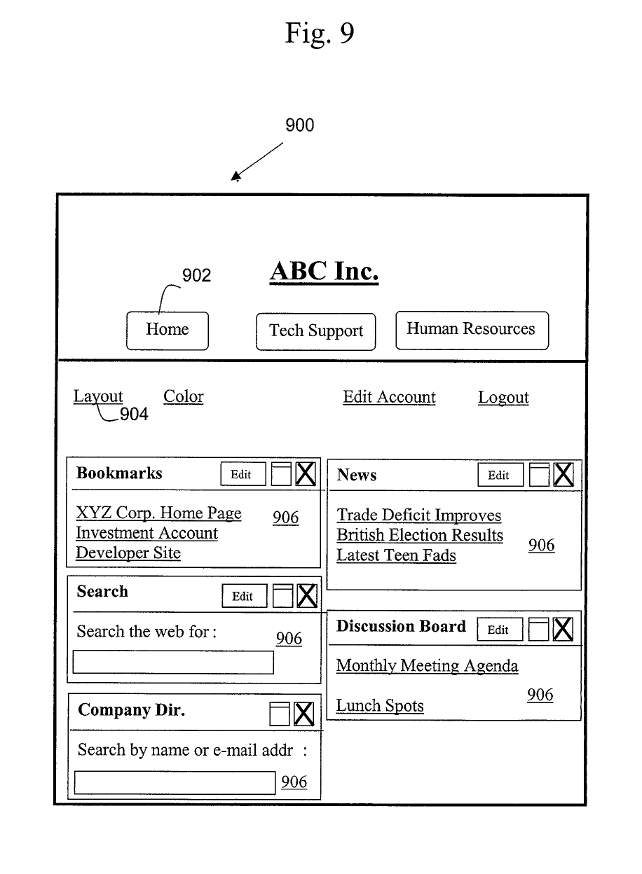

In the embodiment of FIG. 9, an end user interface view for presenting to the end user the particular objects of an instance of a software application is depicted. The end user view is a software application comprising an HTML portal web page 900, identified as a “front page”. In essence, each page presents a predetermined layout of encapsulated module objects containing the resource objects that are available to the user. The top of the page may include a suitable banner containing a corporate logo or the like, and one or more navigation buttons 902 or links, that permit the user to access specific pages associated with the sponsor of the portal, such as the user's employer. Below the banner, another set of buttons or links 904 is displayed, which permit the user to personalize the portal. In the illustrated example, the personalization buttons enable the user to revise the layout of the portal, change its color scheme, and edit that user's account, such as change a password.

Below the banner and the personalization buttons 904, one or more modules 906 are displayed. Each module provides the user with access to a particular type of resource object, such as news headlines or stock quotes. As will be apparent from the discussion that follows, these resource objects can be applications, databases, services, informational content, e-commerce offerings, and the like, that are available in framework 100. Some of these resources objects may be provided by the employer (or other provider of the portal), whereas others may come from independent third parties. By interacting with any one of these modules, the user can access the information or services provided by that module. Thus, by clicking on a headline in the “News” module, the user can be presented with the full text of the news story to which that headline pertains.

While specific embodiments of the present invention have been illustrated and described, it will be understood by those having ordinary skill in the art that changes may be made to those embodiments without departing from the spirit and scope of the invention.

What we claim is:

1. A method of managing the internationalization of software applications of a portal framework employing a navigation graphical user interface, the method comprising the steps of:
acessing an available object from a list of available objects associated with an available object group; and
providing a set of available locales for the available object to a first set of users as defined by a set of permissions for each locale in the set of locales, each locale in the set of available locales representing a cultural scenario;
wherein the available object is associated with a software application.

2. The method according to claim 1, further comprising adding the set of available locales to the portal framework.

3. The method according to claim 2, wherein the set of available locales are added by a second set of users having a first set of administrative privileges associated with the set of available locales.

4. The method according to claim 1, wherein a third set of users have a second set of administrative privileges including an administrative privilege to configure the set of permissions for each of the locales in set of available locales.

5. The method according to claim 4, wherein a first permission in the set of permissions enables providing each locale in the set of available locales to the first set of users.

6. The method according to claim 4, further comprising editing a locale in the set of available locales as specified by the first set of users.

7. The method according to claim 6, wherein editing the locale in the set of locales includes modifying localization information.

8. The method according to claim 7, further comprising storing the modified localization information.

9. The method according to claim 7, wherein a second permission in the set of permissions enables the first set of users to edit the locale in the set of available locales.

10. The method according to claim 1, further comprising traversing a hierarchical path to access the available object.

11. The method according to claim 1, farther comprising selecting an available locale in the set of available locales as one of: a default framework-wide locale and a default system-wide locale.

12. The method according to claim 1, further comprising removing the set of available locales from the portal framework.

13. The method according to claim 12, wherein the set of available locales are removed by a second set of users having a first set of administrative privileges associated with the set of available locales.

14. A computer program product for managing the internationalization of software applications of a portal framework employing a navigation graphical user interface, the computer program product comprising:
a computer readable medium;
computer program instructions, executable by a processor, stored on the computer readable medium operable to:
accessing an available object from a list of available objects associated with an available object group; and
provide a set of available locales for the available object to a first set of users as defined by a set of permissions for each locale in the set of locales, each locale in the set of available locales representing a cultural scenario;
wherein the available object is associated with a software application.

15. The computer program product according to claim 14, further comprising computer program instructions operable to add the set of available locales to the portal framework.

16. The computer program product according to claim 15, wherein the set of available locales are added by a second set of users having a first set of administrative privileges associated with the set of available locales.

17. The computer program product according to claim 14, wherein a third set of users have a second set of administrative privileges including an administrative privilege to configure the set of permissions for each of the locales in set of available locales.

18. The computer program product according to claim 17, wherein a first permission in the set of permissions enables providing each locale in the set of available locales to the first set of users.

19. The computer program product according to claim 17, further comprising computer program instructions operable to edit a locale in the set of available locales as specified by the first set of users.

20. The computer program product according to claim 19, wherein editing the locale in the set of locales includes modifying localization information.

21. The computer program product according to claim 20, further comprising computer program instructions operable to store the modified localization information.

22. The computer program product according to claim 20, wherein a second permission in the set of permissions enables the first set of users to edit the locale in the set of available locales.

23. The computer program product according to claim 14, further comprising computer program instruction operable to traverse a hierarchical path to access the available object.

24. The computer program product according to claim 14, further comprising computer program instructions operable to select an available locale in the set of available locales as one of: a default framework-wide locale and a default system-wide locale.

25. The computer program product according to claim 14, further comprising computer program instructions operable to remove the set of available locales from the portal framework.

26. The computer program product according to claim 25, wherein the set of available locales are removed by a second set of users having a first set of administrative privileges associated with the set of available locales.

27. A system for managing the internationalization of software applications of a portal framework employing a navigation graphical user interface, the method comprising the steps of:
a system operable to access an available object from a list of available objects associated with an available object group; and
a database operable to provide a set of available locales for the available object to a first set of users as defined by a set of permissions for each locale in the set of locales, each locale in the set of available locales representing a cultural scenario;
wherein the available object is associated with a software application.

28. The system according to claim 27, further comprising the system operable to add the set of available locales to the portal framework.

29. The system according to claim 28, wherein the set of available locales are added by a second set of users having a first set of administrative privileges associated with the set of available locales.

30. The system according to claim 27, wherein a third set of users have a second set of administrative privileges including an administrative privilege to configure the set of permissions for each of the locales in set of available locales.

31. The system according to claim 30, wherein a first permission in the set of permissions enables providing each locale in the set of available locales to the first set of users.

32. The system according to claim 30, further comprising the system operable to edit a locale in the set of available locales as specified by the first set of users.

33. The system according to claim 32, wherein editing the locale in the set of locales includes modifying localization information.

34. The system according to claim 33, further comprising the database operable to store the modified localization information.

35. The system according to claim 33, wherein a second permission in the set of permissions enables the first set of users to edit the locale in the set of available locales.

36. The system according to claim 27, further comprising the system operable to traverse a hierarchical path to access the available object.

37. The system according to claim 27, further comprising the system operable to select an available locale in the set of available locales as one of: a default framework-wide locale and a default system-wide locale.

38. The system according to claim 27, further comprising the system operable to remove the set of available locales from the portal framework.

39. The system according to claim 38, wherein the set of available locales are removed by a second set of users having a first set of administrative privileges associated with the set of available locales.
